(19) United States
(12) Patent Application Publication
(10) Pub. No.: US 2014/0304171 A1
(43) Pub. Date: Oct. 9, 2014

(54) METHOD AND SYSTEM TO FACILITATE SOCIAL ECOMMERCE

(71) Applicant: Kudoo BV, Amsterdam (NL)

(72) Inventors: Filip Marc Mertens, Amsterdam (NL); Erwin Martinus van Kralingen, Amsterdam (NL); Rene Pot, Haarlem (NL); David Kelly, Amsterdam (NL)

(73) Assignee: Kudoo BV, Amsterdam (NL)

(21) Appl. No.: 14/244,221

(22) Filed: Apr. 3, 2014

Related U.S. Application Data
(60) Provisional application No. 61/807,882, filed on Apr. 3, 2013.

(51) Int. Cl. G06Q 30/06; G06Q 50/00; G06Q 20/38

(52) U.S. Cl. CPC G06Q 30/0641; G06Q 20/3829; G06Q 50/01
USPC 705/71; 705/27.1

(57) ABSTRACT

Method and system are provided to facilitate social ecommerce. A computer-implemented social ecommerce service may be deployed at one or more server computer systems that may be referred to, collectively as a provider system. A provider system may be in communication with one or more merchant computer systems and one or more on-line social network systems. The social ecommerce service executing at the provider system may be configured to interact with an on-line store and an on-line social service in order to facilitate a process of social ecommerce.

### PRIORITY APPLICATION

This application claims the benefit of priority under 35 U.S.C. 119(e) to U.S. Application Ser. No. 61/807,882, filed on 3 Apr. 2013; which application is incorporated herein by reference in its entirety.

### TECHNICAL FIELD

This application relates to the technical fields of software and/or hardware technology and, in one example embodiment, to system and method to facilitate social ecommerce.

### BACKGROUND

As the growth of ecommerce sites has been increasing, an average ecommerce site may have millions of users worldwide. Typically, an on-line merchant lists items available for sale on an ecommerce site, along with respective prices for the listed items. A buyer may access the merchant site via the Internet using a browser application, select a listed item and complete the transaction using the user interface (UI) controls provided at the merchant's site.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system may be implemented;

FIG. 2 is block diagram of a system to facilitate social ecommerce, in accordance with one example embodiment;

FIG. 3 is a flow chart of a method to facilitate social ecommerce, in accordance with an example embodiment;

FIG. 4 is a diagrammatic representation of an architecture, within which social ecommerce system may be implemented, in accordance with one example embodiment;

FIG. 5 is a diagrammatic representation of interaction between a merchant website and a gift service button, in accordance with one example embodiment;

FIG. 6 is a diagrammatic representation of interaction between a merchant website and a gift service button, in accordance with one example embodiment;

FIG. 6 is a flow chart of a method to create a gift button overlay, in accordance with one example embodiment;

FIG. 7 is a diagrammatic representation of an authentication process in the gift service button, in accordance with one example embodiment;

FIG. 8 is a diagrammatic representation of interaction between a merchant website and a gift service API in the process of completing a sale, in accordance with one example embodiment;

FIG. 9 is a diagrammatic representation of interaction within a social network with respect to giving and receiving gifts utilizing a social commerce system, in accordance with one example embodiment;

FIG. 10-24 illustrate user interface screens rendered on a display device of a user in the process of utilizing a social commerce system; and

FIG. 25 is a diagrammatic representation of an example machine in the form of a computer system within which a set of instructions, for causing the machine to perform any one or more of the methodologies discussed herein, may be executed.

### DETAILED DESCRIPTION

A method and system to facilitate social ecommerce is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

### Overview

Method and system are provided to facilitate social ecommerce. A computer-implemented social ecommerce service (also referred to as a gift service) may be deployed at one or more server computer systems that may be referred to, collectively as a provider system. A provider system may be in communication with one or more merchant computer systems and one or more on-line social network systems. The application executing at the provider system and providing social ecommerce service may be configured to interact with an on-line store and an on-line social service in order to facilitate a process of social ecommerce. The operations performed by the social ecommerce system at the provider system can be outlined as follows.
Detect that a social ecommerce control (which can be any visual control, e.g., a gift service button) was activated at a merchant's site;
determine a product identification associated with the social ecommerce control;
generate a first overlay view, the overlay view comprising data associated with the product identification and a social network link, the social network link facilitating access to an on-line social network service and provide the first overlay view to the merchant's site;
detect activation of the social network link provided in the first overlay view;
generate a second overlay view, the second overlay view permitting selection of a member of the on-line social network service;
detect a selection of a member of the on-line social network service, the selection effectuated via the second overlay view;
provide a third overlay view, the third overlay view comprising a link for effectuating a transaction, the transaction comprising a purchase of a product associated with the product identification and a recipient identified as the selected member of the on-line social network service.

The social ecommerce service, in one example embodiment, is aimed at two example user groups: merchants operating online stores and consumers using online stores to buy gifts. The social ecommerce service may include a number of components, such as web services for delivering the UX (user experiance), visual controls (e.g., gift service buttons) embedded in online stores, widgets that can be triggered by activating an associated visual control, and various computing applications configured for connecting social ecommerce service with social networks.

Example objectives of the social ecommerce service are to improve the process of buying gifts online, as the social ecommerce service may make the process simpler, more relevant, and more interactive; to persuade merchants to embed gift service buttons on their respective websites—merchants subscribe to the social ecommerce service by paying a fee for products sold through the gift service button; persuade consumers to use gift service buttons to buy gifts—consumers do not pay a fee for using the gift service button to buy gifts.

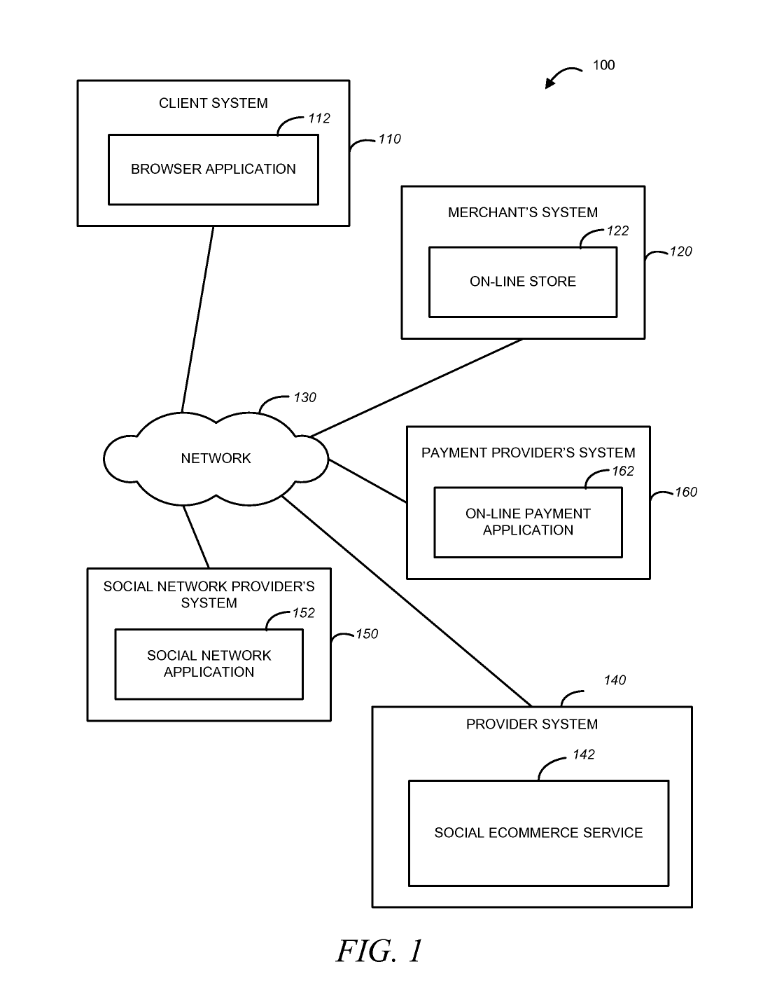

The social ecommerce experience may also be provided in the form of mobile apps. An example method and system to facilitate social ecommerce may be implemented in the context of a network environment 100 illustrated in FIG. 1.

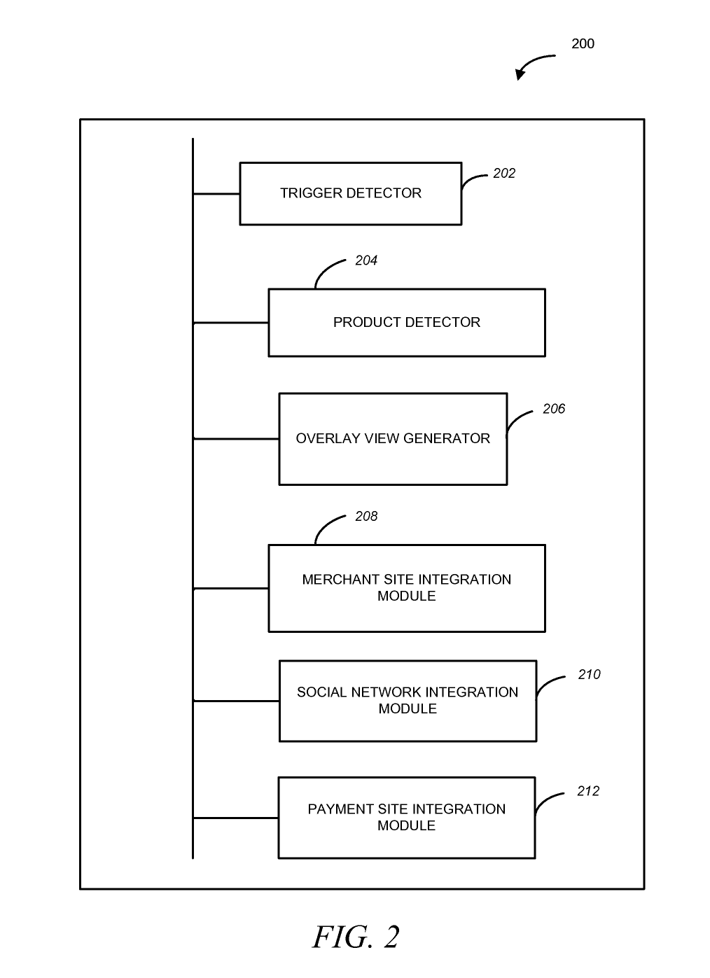

As shown in FIG. 1, the network environment 100 may include a client system 110, a merchant's system 120, and a provider system 140, a social network provider's system 150, and a payment provider's system 160. The client system 110 may run a browser application 112 and may have access to the merchant's system 120, the provider system 140, the social network provider's system 150, and the payment provider's system 160 via a communications network 130. The communications network 130 may be a public network (e.g., the Internet, a mobile communication network, or any other network capable of communicating digital data). The provider system 140 hosts a social ecommerce service 142. Some modules of an example social ecommerce service are illustrated in FIG. 2.

FIG. 2 is a block diagram of a system 200 to facilitate social ecommerce, in accordance with one example embodiment. As shown in FIG. 2, the system 200 includes a trigger detector 202, a product detector 204, and an overlay view generator 206. The trigger detector 202 may be configured to detect that a social ecommerce control was activated at a merchant's site. The social ecommerce control may include encrypted data and an encryption key. The product detector 204 may be configured to determine a product identification associated with the social ecommerce control.

The overlay view generator 206 may be configured to generate overlay views to be provided to a user of the merchant's site. The overlay view generator 206 may receive the encrypted data representing the product and one or more options. The overlay view generator may decrypt the encrypted data using a data key stored in a database in response to the receiving of the encrypted data and generate a first overlay view based on the decrypted data.

The first overlay view may comprise data associated with the product identification and a social network link. The social network link may be utilized to facilitate access to an on-line social network service. The first overlay view is provided to the merchant's site. The trigger detector 202 may also be configured to detect activation of a social network link determine consumer information and create a consumer identification associated with a consumer in response to the detecting activation of the social network link. The overlay view generator 206 generates a second overlay view in response to detecting activation of the social network link. The second overlay view permits selection of a member of the on-line social network service. A third overlay view is provided in response to detecting a selection of a member of the on-line social network service. The selection of a member of the on-line social network service is effectuated via the second overlay view. The overlay view generator 206 also generates the third overlay view comprising a link for effectuating transaction, the transaction comprising a purchase of a product associated with the product identification, a recipient identified as the member of the on-line social network service.

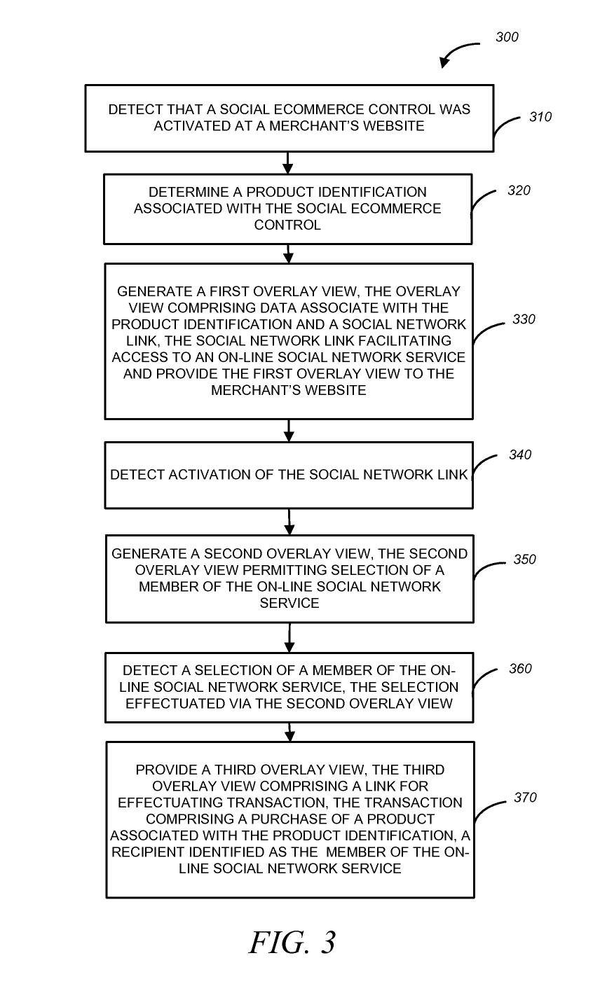

Also shown in FIG. 2 are a merchant site integration module 208 to provide interface between the provider's system and the merchant's system, a social network integration module 210 to provide integration between the provider's system, the merchant's system, and the social network provider's system, and a payment site integration module 212 to provide integration between the provider's system, the merchant's system, and the payment provider's system. An example method to facilitate social ecommerce can be described with reference to FIG. 3.

FIG. 3 is a flow chart of a method 300 to facilitate social ecommerce, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the system 140 of FIG. 1 and, specifically, at the system 200 shown in FIG. 2.

As shown in FIG. 3, the method 300 commences at operation 310, when the trigger detector 202 of FIG. 2 detects that a social ecommerce control was activated at a merchant's site. At operation 320, the product detector 204 of FIG. 2 determines a product identification associated with the social ecommerce control. At operation 330, the overlay view generator 206 of FIG. 2 generates a first overlay view comprising data associated with the product identification and a social network link and provides the first overlay view to the merchant's site. The social network link facilitates access to an on-line social network service. At operation 340, the activation of the social network link is detected and the overlay view generator 206 generates a second overlay view at operation 350. The second overlay view permits selection of a member of the on-line social network service. At operation 360 a selection via the second overlay view of a member of the on-line social network service is detected, and the overlay view generator 206 provides a third overlay view at operation 370. The third overlay view comprises a link for effectuating the transaction of a purchase of a product associated with the product identification, where the recipient of the product is a person identified as the member of the on-line social network service. The system 200 to facilitate social ecommerce may also include a communications module (not shown). The communications module may be configured to receive a request from a merchant to register with a social ecommerce service and, in response to the request, facilitate of the social ecommerce control on a web page provided on the merchant's website.

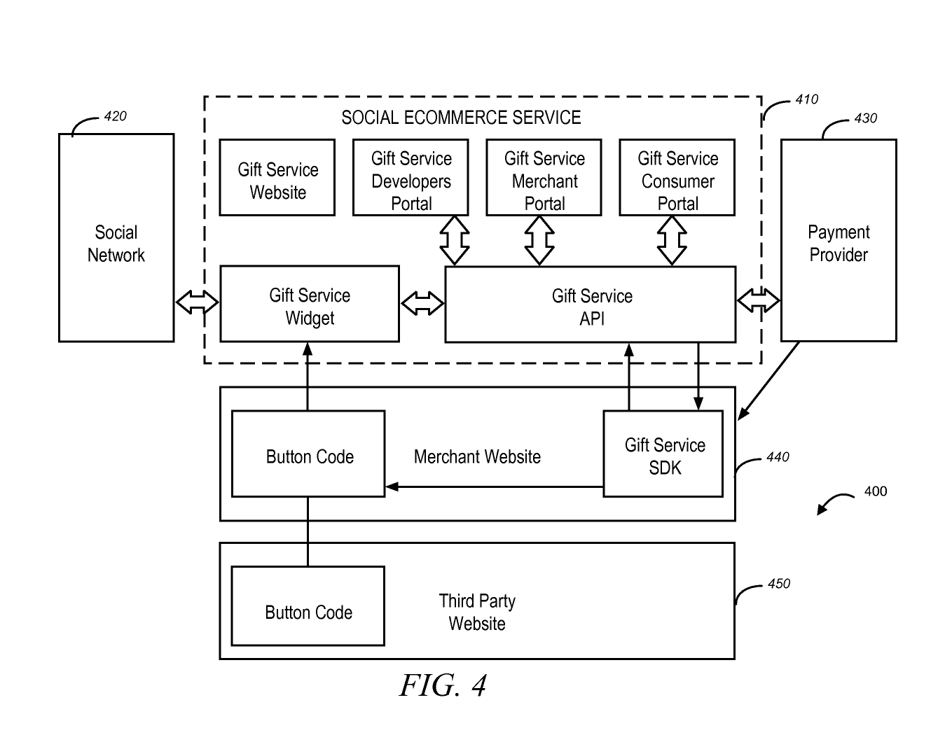

FIG. 4 is a diagrammatic representation of architecture 400, within which social ecommerce system may be implemented, in accordance with one example embodiment. The architecture 400 comprises social ecommerce service 410, a social network system 420, a payment provider system 430, as well as a merchant website 440 and a third party website 450. The social ecommerce service 410 comprises a gift service website, a gift service developers portal, a gift service consumer portal, a gift service widget, and a gift service application programming interface (API). The gift service API interacts with the gift service software development kit (SDK) on the merchant website 440. The gift service widget interacts with the button code of a gift service button on the merchant website 440 and a gift service button the third party website 450. The process of embedding a gift service button on a website may be described as follows.

When signing up for social ecommerce service (also referred to as a gift service), a merchant specifies an email address, a password, and optionally some details about their company in order to be able to include a social ecommerce control on their website. The merchant also specifies information for connecting to a payment service (e.g., an email for PayPal®). Payments can be directed to the merchant's PayPal® account using this email. The merchant then receives API keys for the social ecommerce service. These keys allow the merchant to use a ‘sandbox’ environment to test the gift service button. Another set of keys will allow them to use the social ecommerce service production environment. The merchant can also download the social ecommerce service SDK to connect calls from the social ecommerce service systems to their backend. This is not strictly necessary, as order data can also be downloaded from the merchant portal of the social ecommerce service.

Rendering a social ecommerce control (e.g., a gift service button or simply button) on the merchant's online store may be accomplished by utilizing a JavaScript script. This embedded script, in one embodiment, downloads another piece of JavaScript from the social ecommerce service servers and executes it to render buttons on one or more web pages provided on the merchant's website.

In one embodiment, the social ecommerce service button is a piece of HTML (hypertext mark-up language) code that includes encrypted data and a public API key. The encrypted data represents the product and all the related options. When a consumer clicks the gift service button, the data is decrypted by making a call to the social ecommerce service servers. There, the social ecommerce service API decrypts it using a special data key that is stored in the database. The encrypted data is then rendered as a product in the frame for the buyer. The encryption of data can be done by using the provided SDK. The data can also be encrypted by using the gift service button wizard provided on the merchant portal of the social ecommerce service.

The data structure of the button, in one example embodiment, includes certain fixed fields and options. Fixed fields may refer e.g., to a name, a unique product ID, a price, a description, and an image. Optional fields for the buyer can be delivery options, gift wrap options, and so on. Some options will have a charge attached to it, some will not. This is a decision for the merchant to make. Optional fields for the receiver do not carry a charge. The look and feel of the social ecommerce service button can be specified through a parameter in the HTML code of the button. Each button may include the logo and the name of the social ecommerce service, which may vary in colour and size.

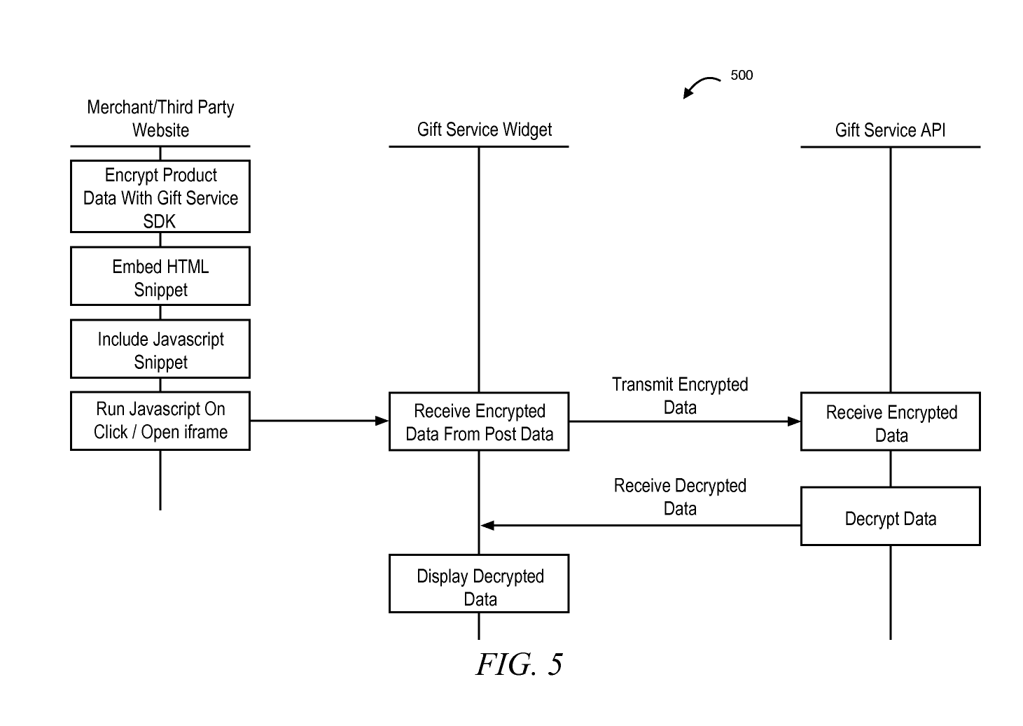

The social ecommerce service SDK, in one embodiment, supports a certain set of functions that act as an endpoint for calls that are made from the social ecommerce service servers to the website of the merchant. When a purchase is accepted (or about to be accepted) these calls will be made: inventory check (optional), and sale push—the details of the accepted gift and its receiver are delivered to the endpoint. The SDK, which receives the call, decrypts the data using the API keys provided in the configuration of the SDK. From there on the backend of the Merchant, it can handle the information and provide a response to the social ecommerce service servers. The way that happens is not necessarily under control of social ecommerce service. The SDK, in one embodiment, provides a universal interface for the incoming calls. If a new version of the SDK is released, the social ecommerce service may notify the Merchant so that they can update their current SDK. As mentioned above, a social ecommerce service may also be referred to as a gift service. FIG. 5 is a diagrammatic representation 500 of interaction between a merchant website and a gift service widget, in accordance with one example embodiment. As explained above, a method to facilitate social ecommerce utilizes a social ecommerce control (e.g., a social commerce button also termed a gift service button) that can be provided on a merchant's website.

A social commerce service system may be configured to generate the button HTML data provided on the fly. It may utilize encryption and the API keys to do so. An example of product data in JSON (JavaScript Object Notation) format, represented by a social commerce button, is shown below in Table 1.

TABLE 1
{

“details”: {

“code”: “4506”,
“name”: “Accidents”,
“description”: “This design was chosen from the Arcade Fire

Design Challenge and is part of Threadless Causes, community-based
design for the power of good. 25 of sales from this tee will go to Partners
In Health to provide healthcare to the worlds poorest in Haiti and
countries around the globe.”,

| “price”: 1950, | |
|---|---|
| “image”: | “http://s3.amazonaws.com/threadless- |

shop/products/4506/636x460shirt_guys_01.jpg”

},
“options”: {

“recipient”: {

“size”: {

“id”: “size”,
“mandatory”: “true”,
“type”: “single_choice”,
“name”: “Shirt Size”,
“choices”: {

“0”: {

“id”: “xl”,
“name”: “XL”

},
“1”: {

“id”: “2xl”,
“name”: “2XL”

},
“s”: {

“id”: “s”,
“name”: “S”

},
“m”: {

“id”: “m”,
“name”: “M”

},
“l”: {

“id”: “l”,
“name”: “L”

}

}

}

},
“buyer”: {

“delivery”: {

“id”: “delivery”,
“type”: “delivery”,
“name”: “Delivery Option”,
“description”: “Delivery”,
“choices”: {

“Europe”: {

“id”: “europe”,
“price”: “900”,
“name”: “Europe”

},
“usa”: {

“id”: “usa”,
“price”: “499”,
“name”: “United States”

}

}

},
“gender”: {

“id”: “gender”,
“name”: “Shirt Type”,
“type”: “single_choice”,
“mandatory”: “true”,
“choices”: {

“guys”: {

“id”: “guys”,
“name”: “Guys”

},
“girly”: {

“id”: “girly”,
“name”: “Girly”

}

}

}

}

}

}

The gift service button code may be rendered on any page that contains the JavaScript script, including blogs, banners, tabs on a social network web page, etc. Any type of product or service can be sold through a social ecommerce service.

The merchant portal at the social ecommerce service website provides the merchant with various functionalities and data points, such as sign up, sign in, account settings, view/manage open orders, API and implementation documentation, sandbox for testing buttons, etc.

Button integration procedure at a merchant's system, according to one example embodiment, may include the following operations.
1. Sign up for an account with the social ecommerce service and register with a payment provider.
2. Receive API keys for encryption and decryption from the social ecommerce service.
3. Download the SDK (optional) from the social ecommerce service website.
4. Attach SDK to public endpoint on the merchant's system (optional).
5. Connect functionalities of SDK to the backend of the merchant's system (optional).
6. Generate button code (manually or via SDK).
7. Put button code anywhere on a web page provided by the merchant's system.
8. Include Javascript snippet on the web page provided by the merchant's system.

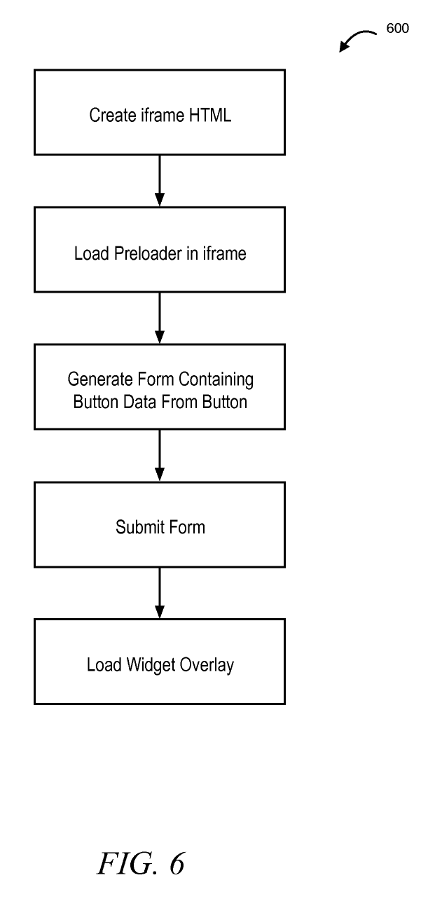

As explained above, when the social ecommerce service detects that a gift button was activated at a merchant's site and determines an associated product ID, the social ecommerce service generates an overlay view comprising data associated with the product identification and a social network link. FIG. 6 is a flow chart of a method 600 to create a gift button overlay, in accordance with one example embodiment.

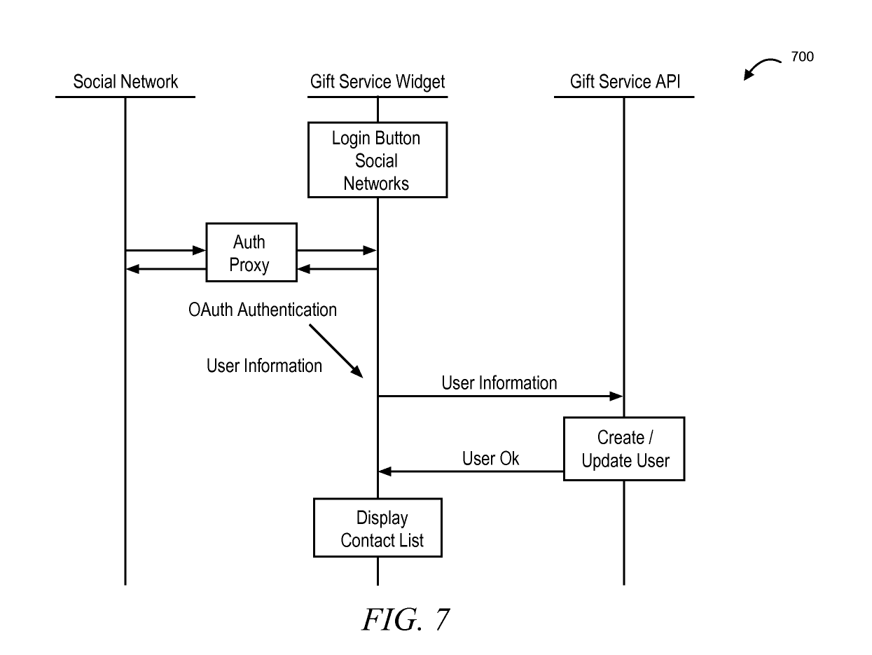

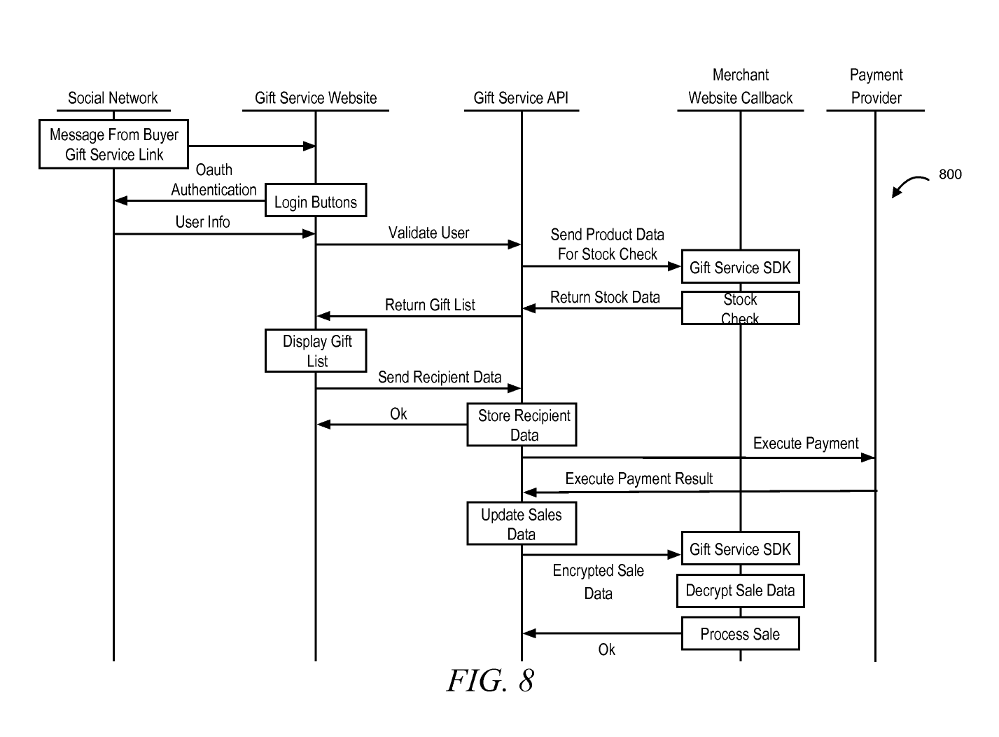

FIG. 7 is a diagrammatic representation of an authentication process 700 in the gift service button, in accordance with one example embodiment. FIG. 7 illustrates operations performed between the on-line social network 420 of FIG. 4, the gift service widget provided by the social ecommerce service of FIG. 4, and the gift service API provided by the social ecommerce service of FIG. 4. In one embodiment, the authentication process that takes place between the on-line social network and the gift service widget utilizes an open protocol (“OAuth”). The user information obtained as the result of authentication is provided to the gift service API, which, in turn, permits the gift service widget to display a contact list to a user that activated a gift button. FIG. 8 is a diagrammatic representation of interaction between a merchant website and a gift service API in the process of completing a sale, in accordance with one example embodiment.

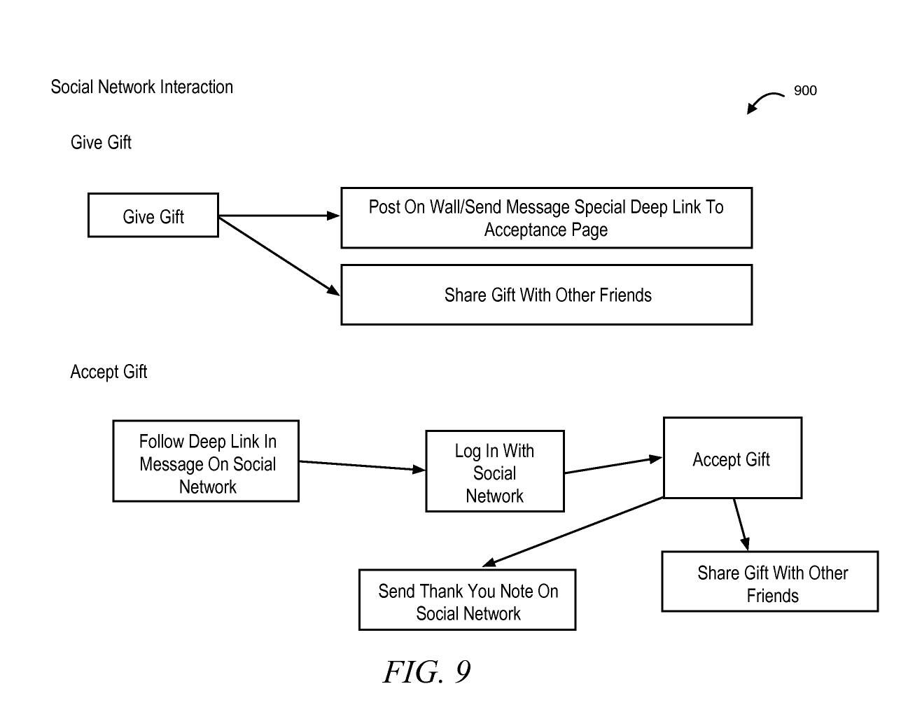

FIG. 9 is a diagrammatic representation of interaction within a social network with respect to giving and receiving gifts utilizing a social commerce system, in accordance with one example embodiment. As shown in FIG. 9, a user who is giving a gift utilizing the social ecommerce service may share the gift with his connections within the on-line social network and/or post a message on the recipient's wall within the on-line social network. In order to accept a gift that was initiated utilizing the social ecommerce service, the recipient of the gift may follow a deep link message associated with the gift, log into the on-line social network, and accept or reject the gift using one or more visual controls presented on a web page provided by the on-line social network. The recipient of the gift may also share the gift with other members of the on-line social network.

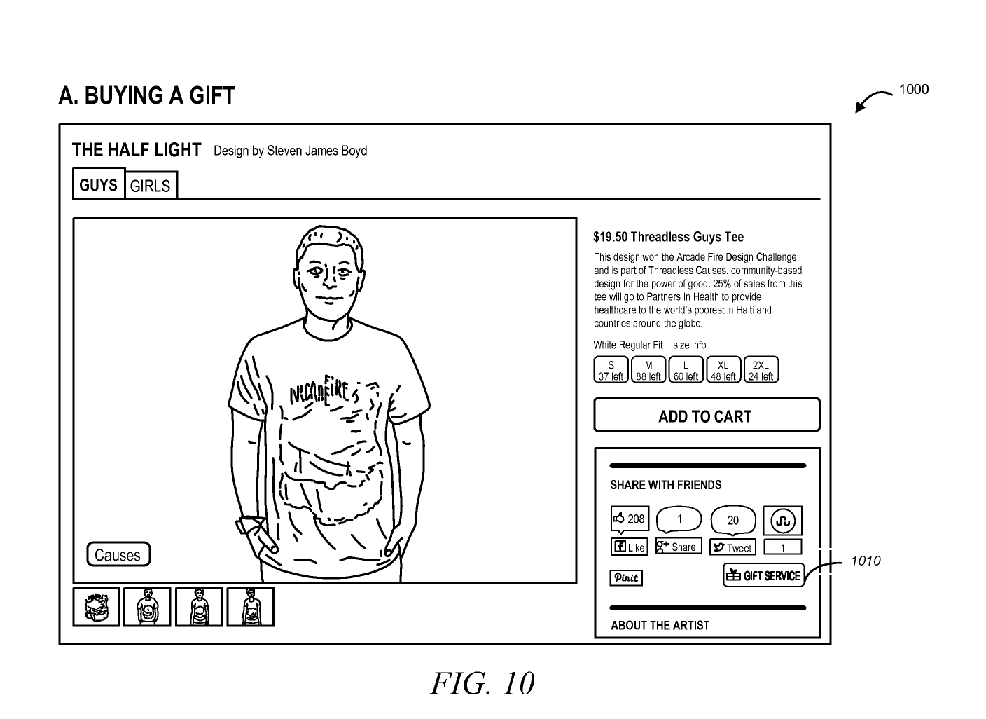

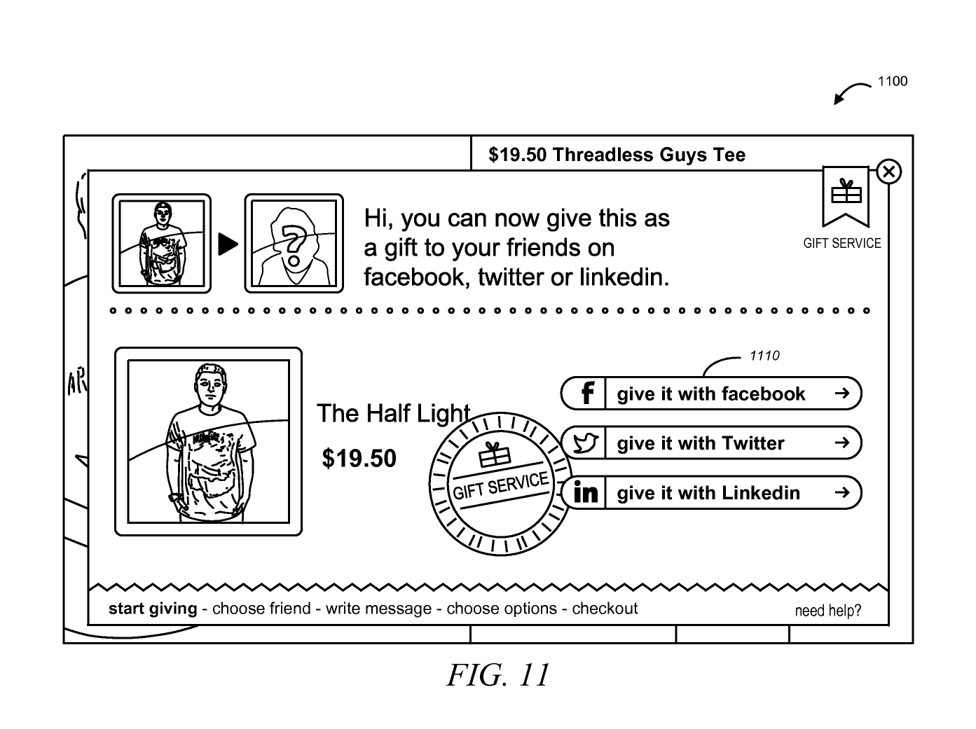

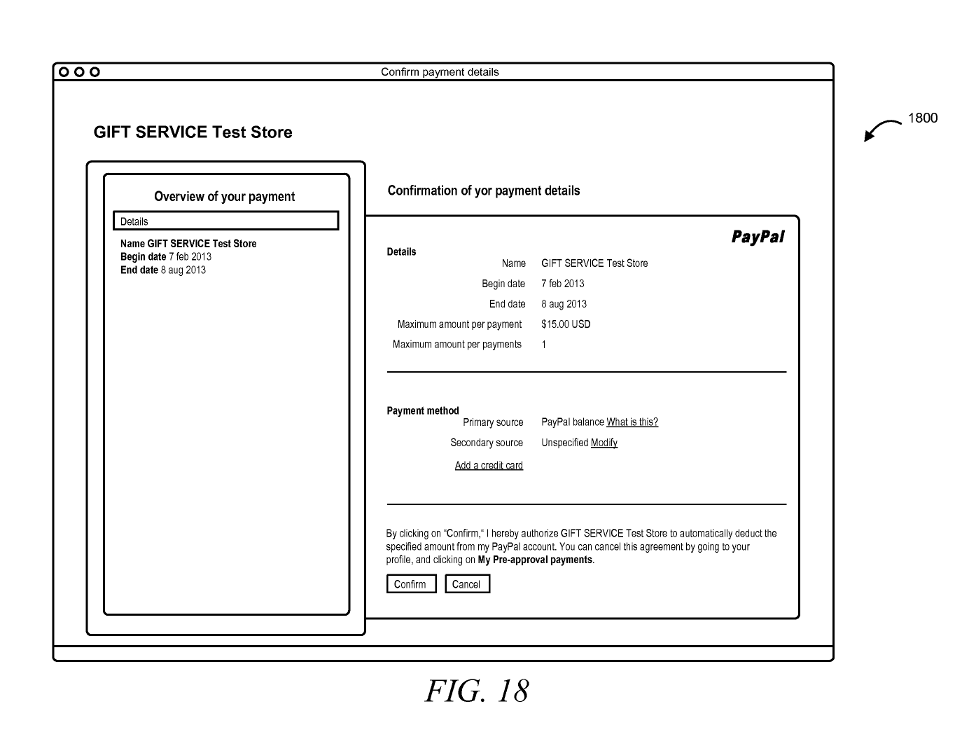

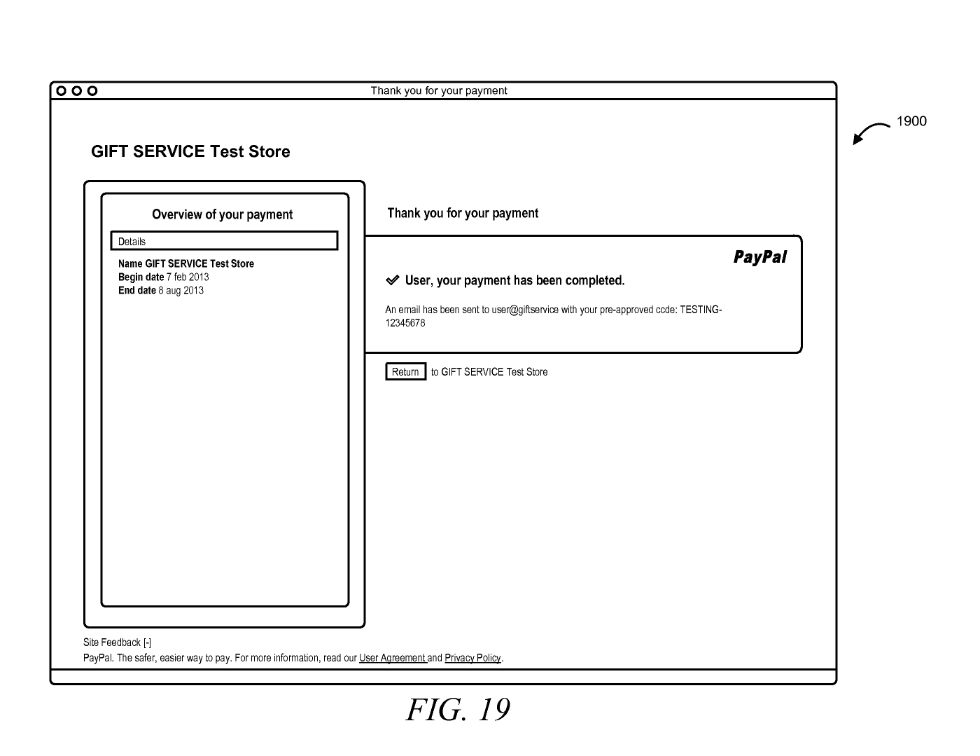

FIG. 10-24 illustrate user interface screens rendered on a display device of a user in the process of utilizing a social commerce system. In operation, the social ecommerce service may be utilized as follows. A consumer is visiting an online store. On the gift service website, a consumer sees a product, which would make a nice gift for their friend. Displayed next to the product description is a gift service button 1010 (screen 1000 shown in FIG. 10). The consumer clicks the gift service button 1010. The gift service widget appears as an overlay on top of the web page shown as the screen 1000 (screen 1100 shown in FIG. 11). The gift service widget contains information about the product associated with the button placement (e.g. picture, description, price), and explanations and instructions regarding how to use the Give.it service.

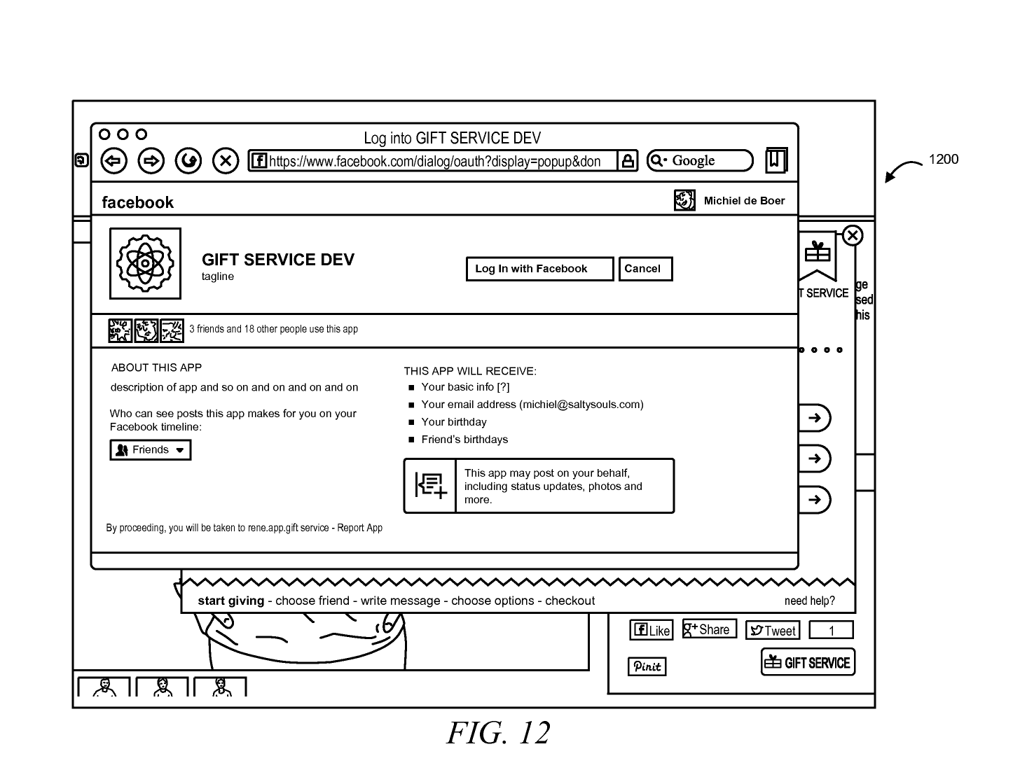

The consumer may choose to connect to the social ecommerce service using one or more social networks the consumer is a member of, e.g., by activating a visual control 1110. A login screen that permits a user to connect to the social ecommerce service using an on-line social network is shown in FIG. 12 as screen 1200. When the consumer connects with a social network, the social network system permits the social ecommerce service associated with that particular network to access relevant data associated with the consumer on that network.

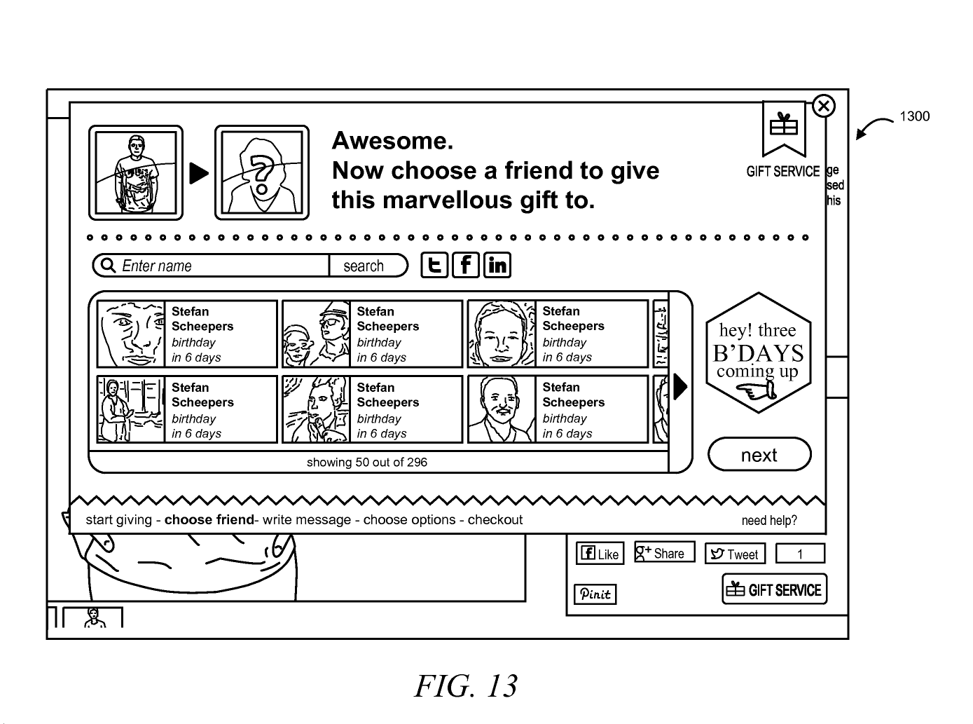

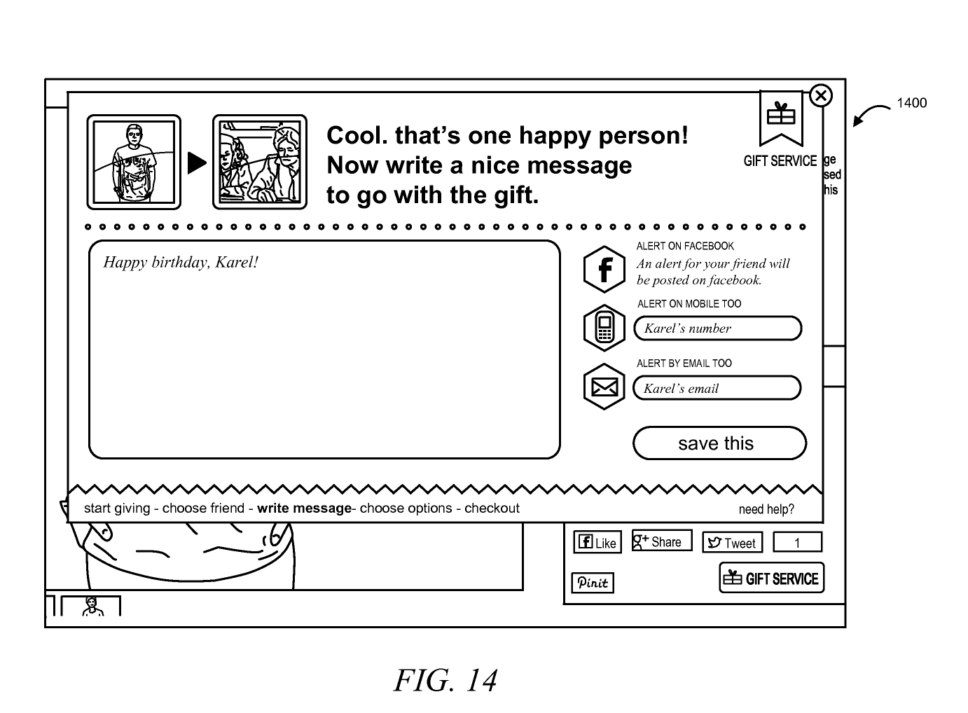

Each consumer that becomes a user of the social ecommerce service by connecting to a social network is assigned a unique ID with respect to the social ecommerce service. The ID is also associated with the social network that was selected by the consumer. The data accessed for the consumer at the social network is stored on the social ecommerce service servers. The data may contain (depending on the network and its settings) consumer's name, consumer's username, consumer's email address, list of contacts of the consumer in the on-line social network (in the form of user ID, name, and username), consumer's date of birth, birthdays of contacts of the consumer, emails of contacts of the consumer, etc. After the connection with a social network is successful, the consumer selects a contact from the contact list on that network (screen 1300 shown in FIG. 13). Depending on the network, there may be additional lists available, such as a list of birthdays. Next, the Consumer can write a personal message for the receiver of the gift (screen 1400 shown in FIG. 14). This message is stored on the social ecommerce service servers.

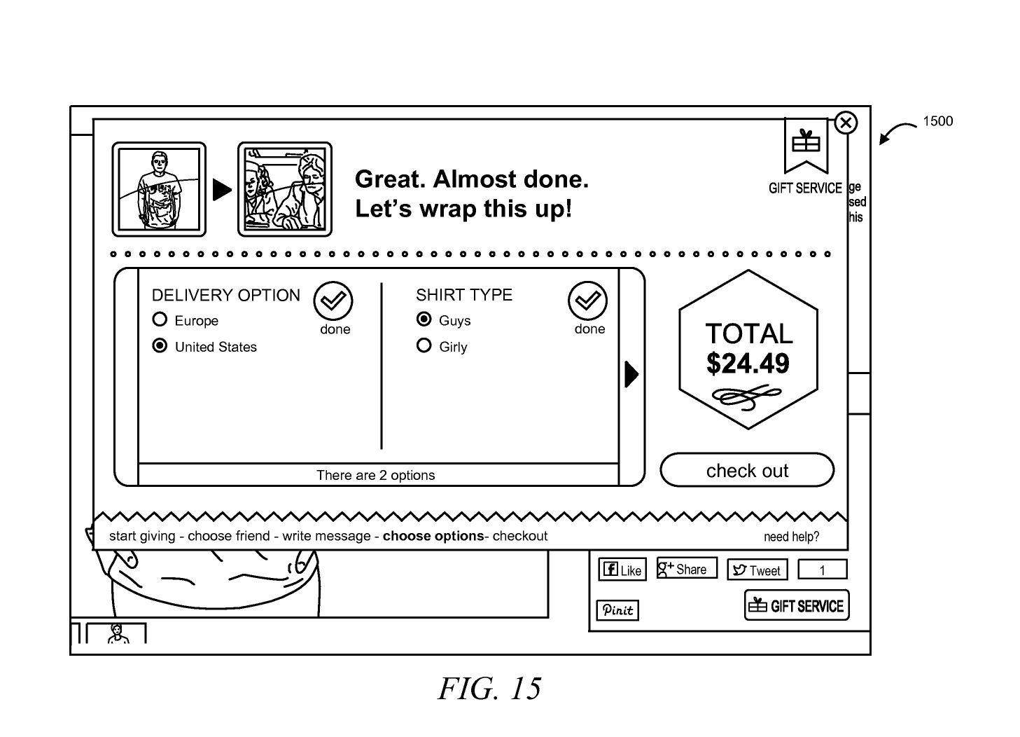

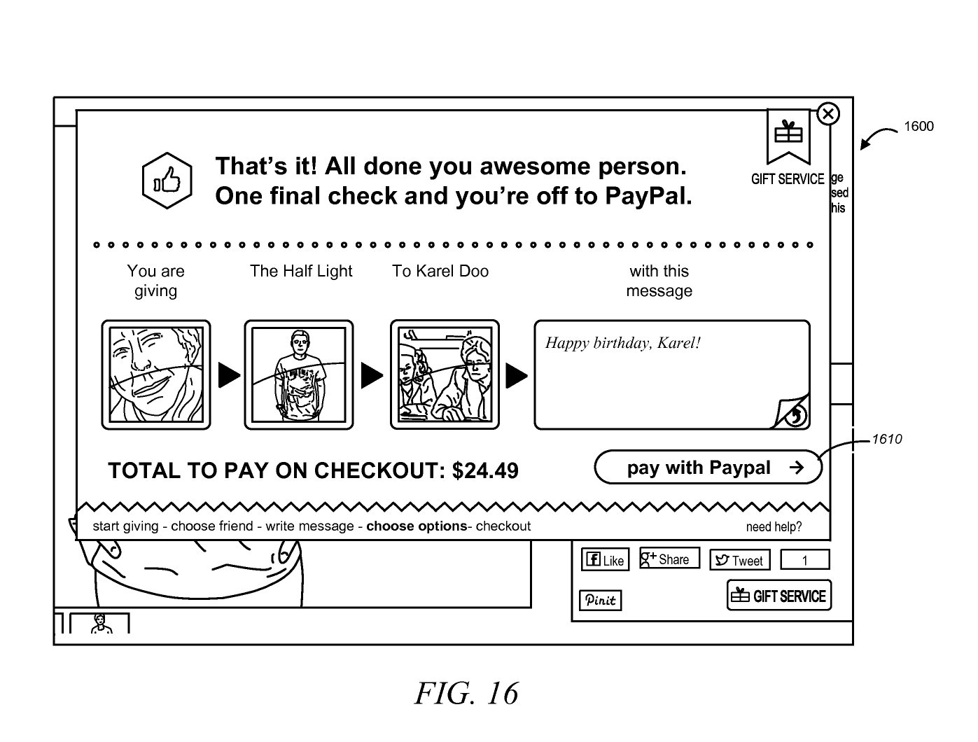

Next, the consumer can choose from a variety of delivery options, such as, for example, gift wrap (screen 1500 shown in FIG. 15). These options may affect the price of the gift purchase. Based on the options selected, the consumer is presented with a total price and a payment button 1610 in the widget (screen 1600 shown in FIG. 16).

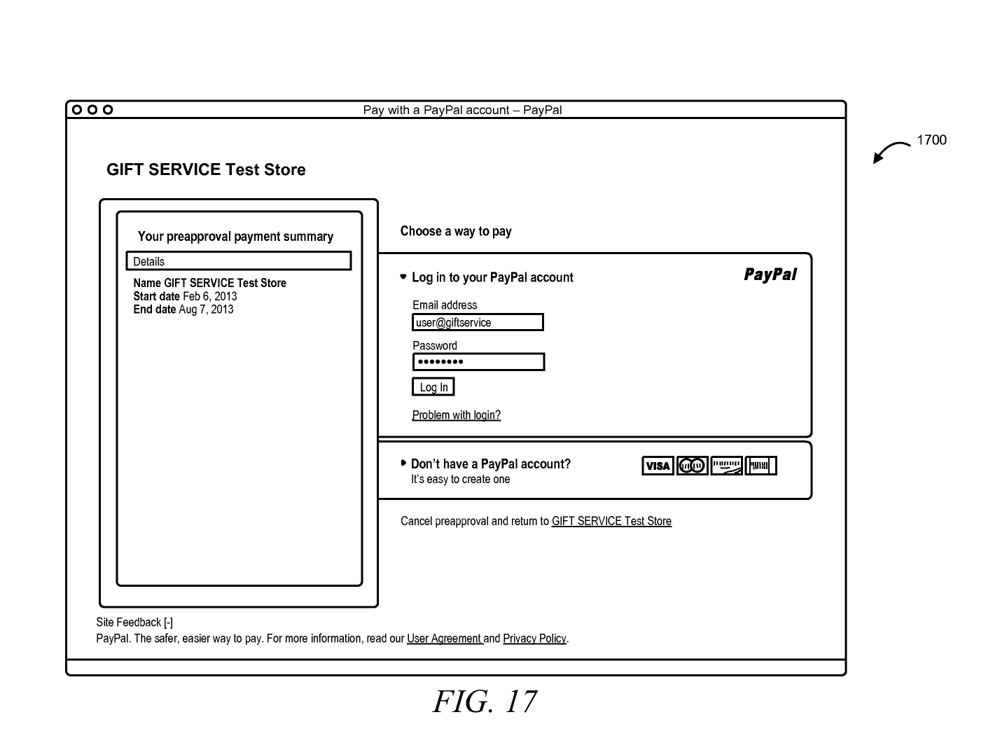

The consumer is the presented with secure payment screens (screens 1700, 1800 and 1900 shown in FIG. 17-19). The consumer signs in to the payment system using their email address and password associated with the payment system. The Consumer creates a pre-approval of the payment to the merchant, processed by the payment system on behalf of the social commerce system.

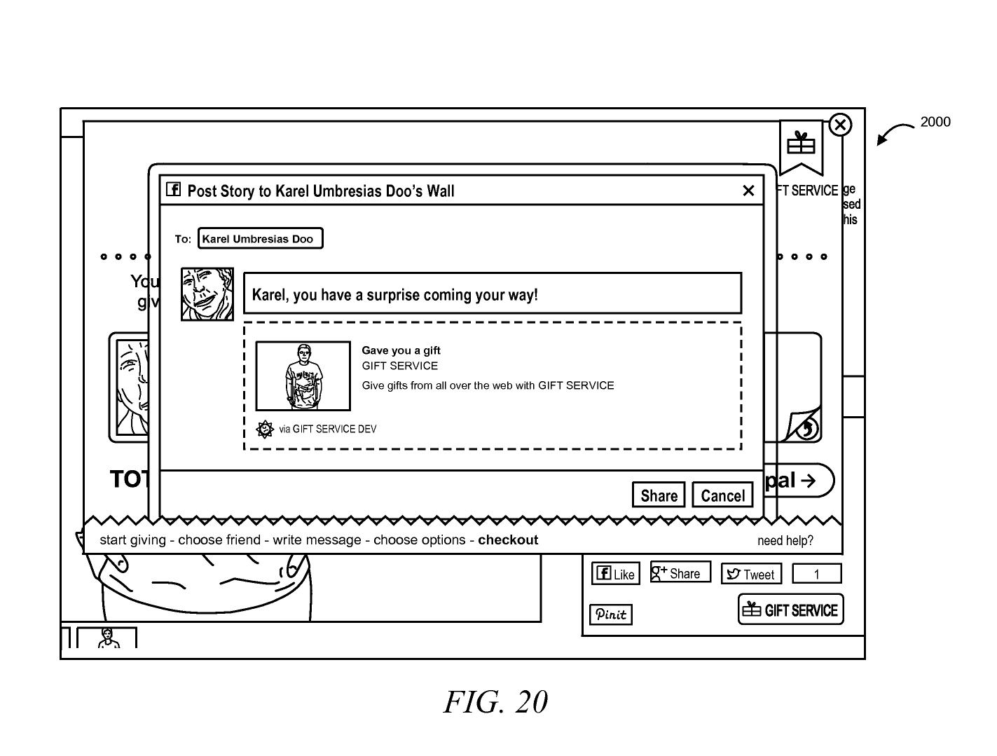

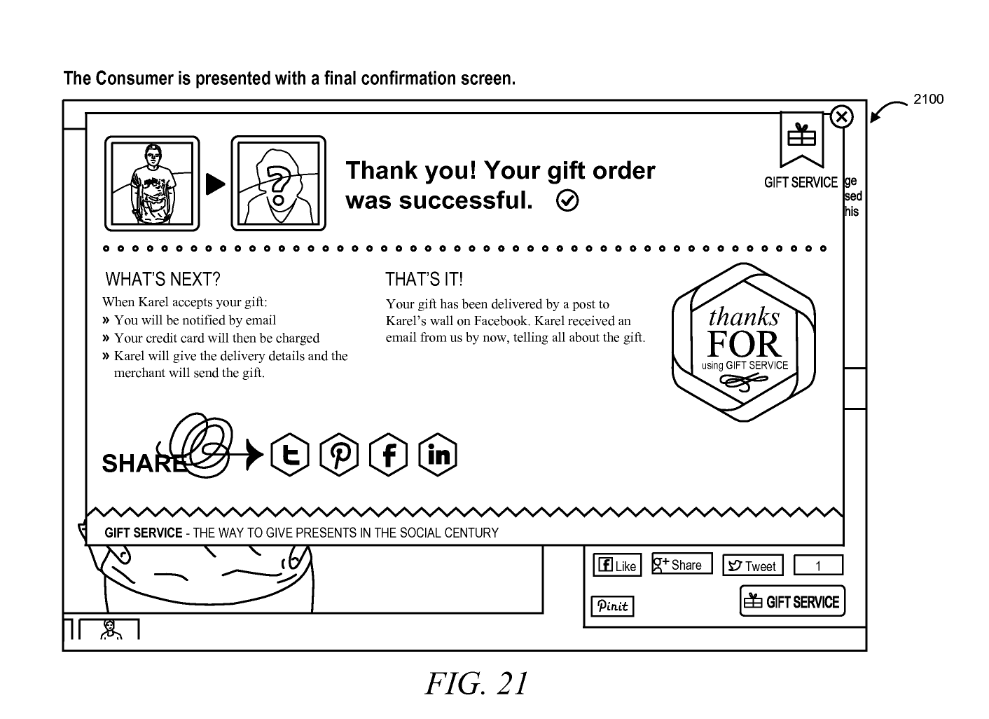

Next, the consumer is prompted to notify the receiver by offering a number of communication channels, including the connected social networks, email, and text message (screen 2000 shown in FIG. 20). The Consumer is presented with a final confirmation screen 2100 shown in FIG. 21. Depending on the social network connected to, the consumer receives an email from the social ecommerce system confirming the pre-approved payment. The consumer can access the website provided by the social ecommerce system to check the status of the gift.

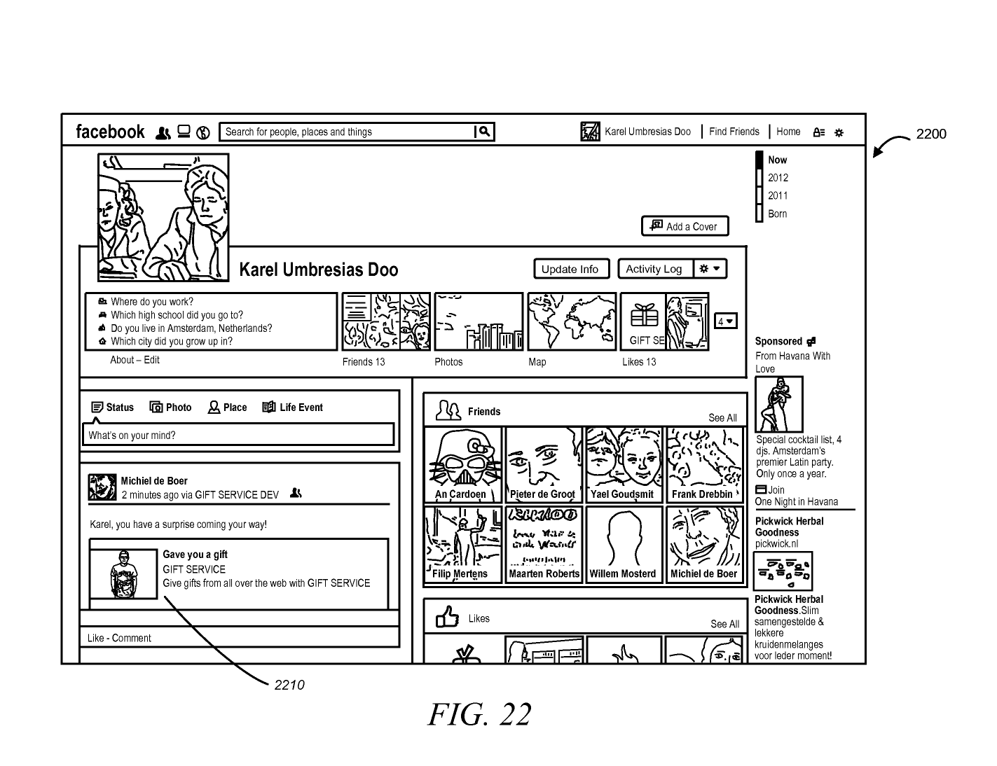

A consumer that has been given a gift through the social ecommerce system receives a message (screen 2200 shown in FIG. 22), on a social network, email, or text message (as selected by the buyer). Depending on the capabilities of the API of the social network selected by the buyer, the message can be a private or public one. The message contains a link 2210 to the social ecommerce system website.

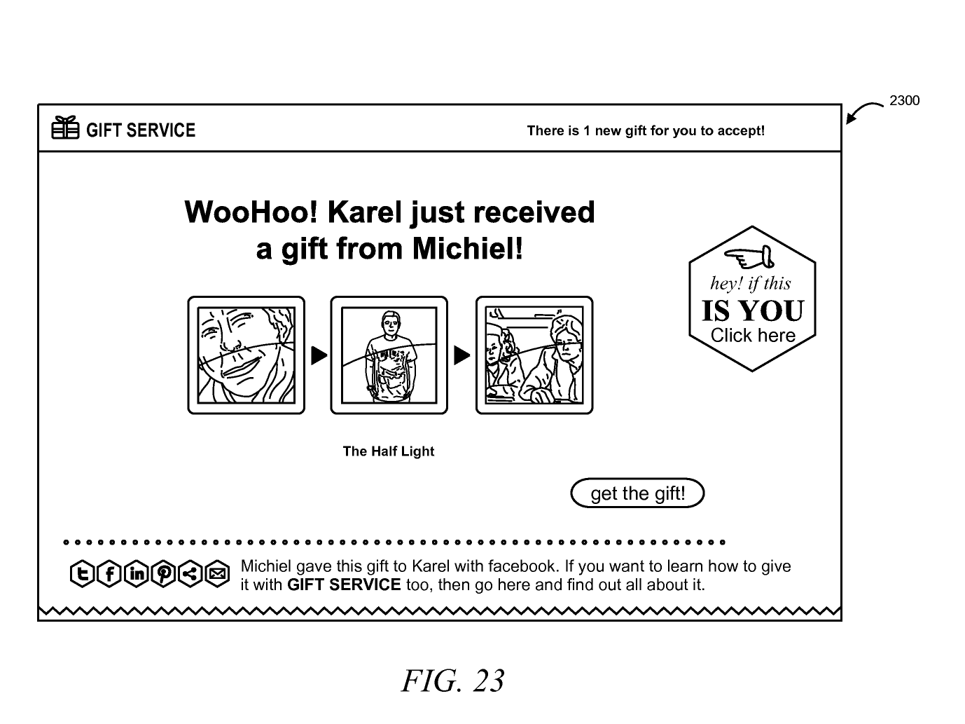

When visiting the social ecommerce system website, and after connecting with the social network through which the consumer was notified, they see all gifts that have been given to them (screen 2300 shown in FIG. 23).

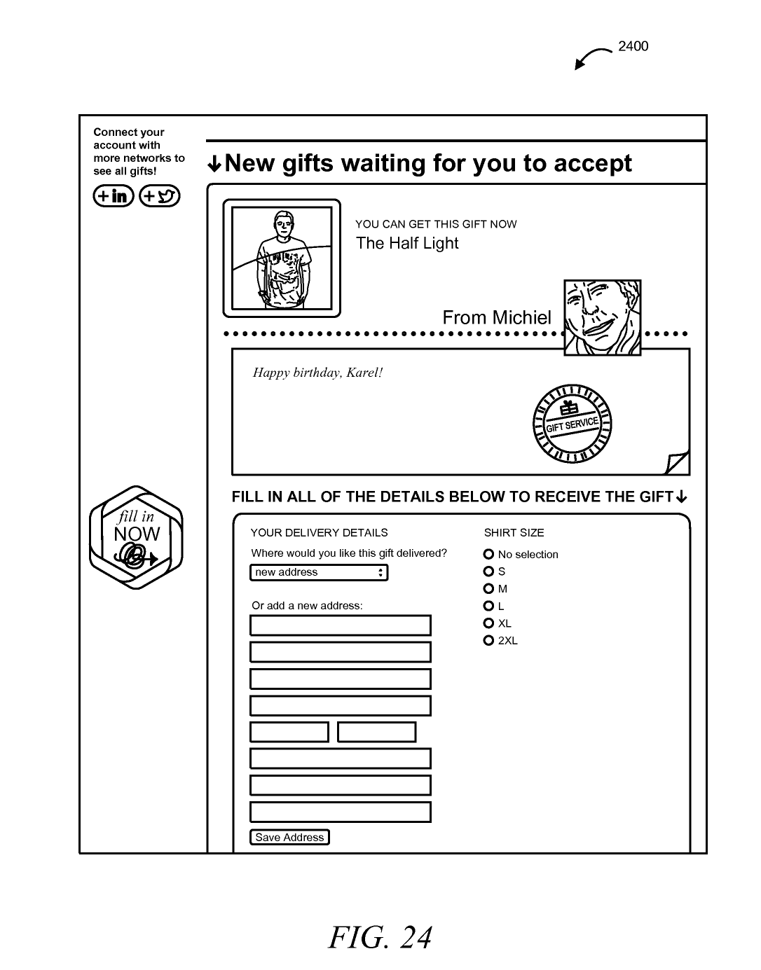

The intended recipient can accept or decline the gift (screen 2400 shown in FIG. 24). In case of a decline, nothing happens. The payment that was pre-approved is then cancelled, the merchant registers no sale and does not ship the product. A merchant has the option to specify an inventory check, which is done prior to accepting. If the product is out of stock, the payment, sale and shipment can be cancelled by the merchant. Depending on the type of gift, the receiver must fill out some details, such as a delivery address or email that the social ecommerce system will send to the merchant for processing. These details are stored on the social ecommerce system servers.

In certain cases, the merchant may specify several options the receiver can choose from, such as, e.g., colour, size, etc. These options do not necessarily affect the price of the sale. When the receiver accepts the gift the pre-approved payment is executed. The money, minus the fees by the social ecommerce system, may be transferred directly to the account of the merchant. Both the buyer and the receiver of the gift receive email messages from the social ecommerce system, notifying them of the transaction.

An example social ecommerce service may be extended as follows. In the merchant portal or through the SDK, merchants can print images of the gift service button with a quick response (QR) code in it. They can stick these images to anything in a physical environment, like packaging, point-of-sale materials, flyers. Consumers can scan this QR code with a mobile social ecommerce service app. The QR code may include the same encrypted data as is the case where the social ecommerce s button is provided on a web page. The consumer can then proceed to buy the gift through the mobile application.

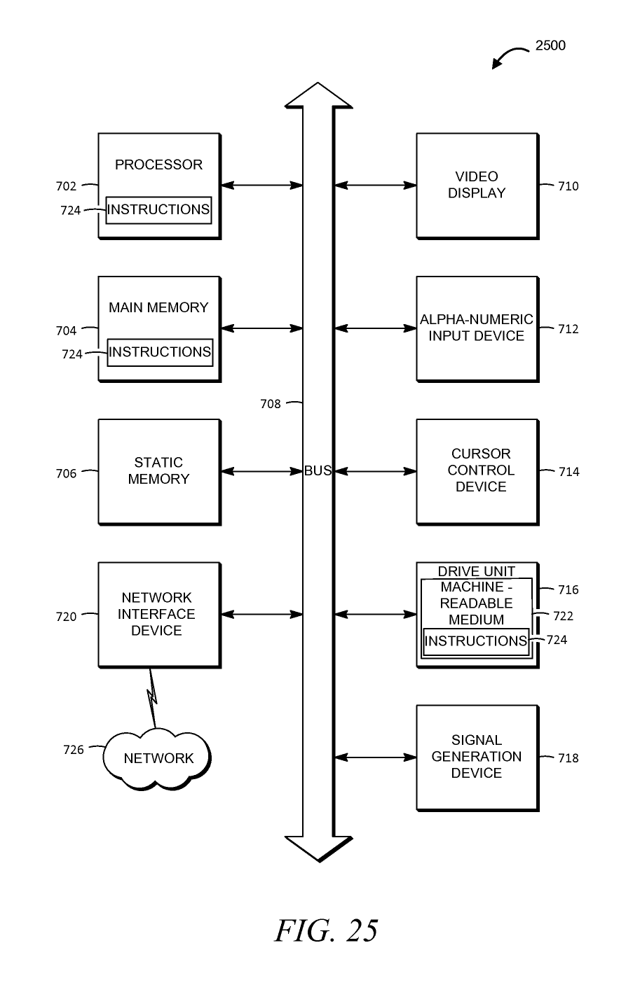

FIG. 25 is a diagrammatic representation of a machine in the example form of a computer system 2500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to facilitate social ecommerce have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented method comprising:
using one or more processors to perform operations of:
detecting that a social ecommerce control was activated at a merchant's website;
determining a product identification associated with the social ecommerce control;
generating a first overlay view, the overlay view comprising data associated with the product identification and a social network link, the social network link facilitating access to an on-line social network service and provide the first overlay view to the merchant's website;
detecting activation of the social network link;
generating a second overlay view, the second overlay view permitting selection of a member of the on-line social network service;
detecting a selection of a member of the on-line social network service, the selection effectuated via the second overlay view; and
providing a third overlay view, the third overlay view comprising a link for effectuating transaction, the transaction comprising a purchase of a product associated with the product identification, a recipient identified as the member of the on-line social network service.

2. The method of claim 1, comprising:
receiving a request from a merchant to register with a social ecommerce service; and
in response to the request, facilitating of the social ecommerce control on a web page provided on the merchant's website.

3. The method of claim 1, comprising:
in response to the detecting activation of the social network link, determining consumer information and creating a consumer identification associated with a consumer.

4. The method of claim 1, wherein the social ecommerce control comprises encrypted data and an encryption key.

5. The method of claim 4, wherein the detecting that the social ecommerce control was activated comprises receiving the encrypted data, the encrypted data representing the product and one or more options.

6. The method of claim 5, comprising in response to the receiving of the encrypted data, decrypting the encrypted data using a data key stored in a database.

7. The method of claim 6, wherein the generating of the first overlay view is based on the decrypted data.

8. The method of claim 1, wherein the social ecommerce control is associated with a data structure, the data structure comprising one or more fields, a field from the one or more fields.

9. The method of claim 8, wherein a field from the one or more fields is a fixed field comprising the product identification.

10. The method of claim 8, wherein a field from the one or more fields is an optional field comprising a delivery option or a gift wrap option.

11. A computer-implemented system comprising:
at least one processor coupled to a memory;
a trigger detector to detect that a social ecommerce control was activated at a merchant's website, using the at least one processor;
a product detector to determine a product identification associated with the social ecommerce control, using the at least one processor;
an overlay view generator to, using the at least one processor:
generate a first overlay view, the overlay view comprising data associated with the product identification and a social network link, the social network link facilitating access to an on-line social network service and provide the first overlay view to the merchant's website,
generate a second overlay view in response to detecting activation of the social network link, the second overlay view permitting selection of a member of the on-line social network service;
provide a third overlay view in response to detecting a selection of a member of the on-line social network service, the selection effectuated via the second overlay view, the third overlay view comprising a link for effectuating transaction, the transaction comprising a purchase of a product associated with the product identification, a recipient identified as the member of the on-line social network service.

12. The system of claim 11, comprising a communications module to, using the at least one processor:
receive a request from a merchant to register with a social ecommerce service; and
in response to the request, facilitate of the social ecommerce control on a web page provided on the merchant's website.

13. The system of claim 11, wherein the trigger detector is to:
in response to the detecting activation of the social network link, determine consumer information and creating a consumer identification associated with a consumer.

14. The system of claim 11, wherein the social ecommerce control comprises encrypted data and an encryption key.

15. The system of claim 14, wherein the overlay view generator is to receive the encrypted data, the encrypted data representing the product and one or more options.

16. The system of claim 15, wherein the overlay view generator is to decrypt the encrypted data using a data key stored in a database in response to the receiving of the encrypted data.

17. The system of claim 16, wherein the overlay view generator is to generate the first overlay view is based on the decrypted data.

18. The system of claim 11, wherein the social ecommerce control is associated with a data structure, the data structure comprising one or more fields, a field from the one or more fields.

19. The system of claim 18, wherein a field from the one or more fields is a fixed field comprising the product identification.

20. A machine-readable non-transitory storage medium having instruction data to cause a machine to:
detect that a social ecommerce control was activated at a merchant's website;
determine a product identification associated with the social ecommerce control;
generate a first overlay view, the overlay view comprising data associated with the product identification and a social network link, the social network link facilitating access to an on-line social network service and provide the first overlay view to the merchant's website;
detect activation of the social network link;
generate a second overlay view, the second overlay view permitting selection of a member of the on-line social network service;
detect a selection of a member of the on-line social network service, the selection effectuated via the second overlay view; and
provide a third overlay view, the third overlay view comprising a link for effectuating transaction, the transaction comprising a purchase of a product associated with the product identification, a recipient identified as the member of the on-line social network service.
